(19) United States
(12) Patent Application Publication
(10) Pub. No.: US 2019/0019229 A1
(43) Pub. Date: Jan. 17, 2019

(54) COMMUNICATION SYSTEM FOR PRESENTING WORKS OF AUTHORSHIP TO REVIEWERS

(71) Applicant: Pitch Comedy, Inc., Los Angeles, CA (US)

(72) Inventors: Yin Hui Zhu, San Jose, CA (US); Bradley Scott Mahler, Cinicnnati, OH (US); Matthew Gregory Klinman, Brooklyn, NY (US)

(21) Appl. No.: 16/031,915

(22) Filed: Jul. 10, 2018

Related U.S. Application Data
(60) Provisional application No. 62/533,658, filed on Jul. 17, 2017.

(51) Int. Cl. G06Q 30/02; G06F 17/18; G06F 17/30

(52) U.S. Cl. CPC G06Q 30/0282; G06F 17/30699; G06F 17/18

(57) ABSTRACT

A networked, computer-based pitch-filtering system allows an intermediary to assist authors in presenting works of authorship (i.e., “pitching”) to potential reviewers. The intermediary maintains a pitch server and related client software that together filter the presentation of pitches to a community of reviewers. Pitch fading screens out relatively poor-quality pitches over time to keep reviewers engaged and emphasize the best material. During the review process pitches are maintained confidential within a group of reviewers. Pitches that receive positive feedback can be offered to potential customers within or outside of the reviewer group.

### FIELD OF THE INVENTION

The present invention relates generally to electronic-commerce (e-commerce), and in particular to methods and systems for prioritizing the presentation of works of authorship to potential reviewers.

### BACKGROUND

Authors and artists have long struggled to find buyers for their expressions of creative skill and imagination. Electronic commerce, largely supported by the emergence of the Internet, has made reaching and interacting with potential customers much easier. Unfortunately, the ease with which sellers can broadcast offers and content has resulted in deluges of marketing materials, commonly of questionable quality, that overwhelm potential buyers. Promotions of desirable creative expression are overlooked by interested buyers as needles in a haystack. There is therefore a need for less intrusive mechanisms for introducing quality works of authorship to potential customers.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1 depicts a networked, computer-based communication system 100 that assists authors in presenting works of authorship to potential reviewers.

### DETAILED DESCRIPTION

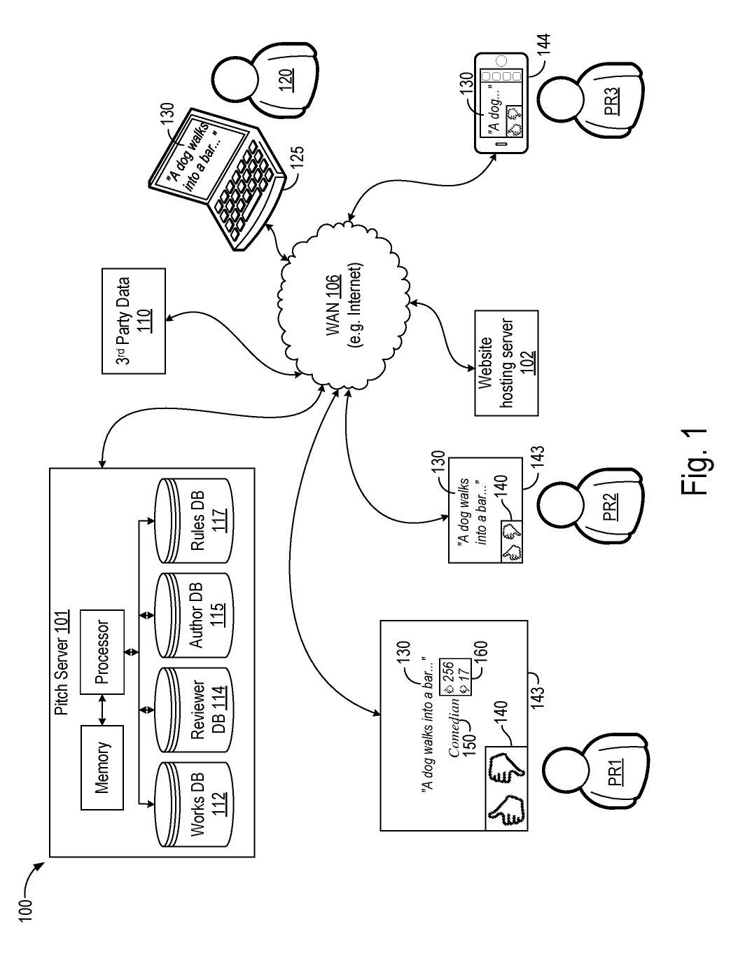

FIG. 1 depicts a networked, computer-based pitch-filtering system 100 that allows an intermediary to assist authors in presenting works of authorship (i.e., “pitching”) to potential reviewers. In this embodiment, the intermediary maintains a pitch server 101 and related client software that together filter the presentation of jokes to reviewers. Pitch server 101 supports a feature called “pitch fading” that improves the average quality of jokes presented to potential reviewers by screening out relatively poor-quality jokes. Reviewers thus stay engaged and the best material works its way to the top. During the review process jokes are maintained confidential within a group of reviewers with controlled-access network accounts to server 101. Jokes that receive positive feedback can then be offered to potential customers within or outside of the reviewer group.

Pitch server 101 supports a website-hosting server 102 and may have access to third-party data 110 via a wide-area network 106 (e.g., the Internet). Pitch server 101 maintains a works database 112 that maintains a list of salable works of authorship, such as literary, dramatic, musical, artistic, and certain other intellectual works. Pitch server 101 also maintains a reviewer database 114 that lists potential reviewers, an author database 115 relating authors to respective works to authorship, and a rules database 117 listing rules for presenting named or anonymous works of authorship to sets of potential reviewers. The authors and reviewers (collectively “users”) can overlap, and these and other data can be stored in the same or different databases. This example shows a comedian 120 in communication with server 101 via a client device 125 sharing a joke 130. The reviewers in this example may include e.g. editors, collaborators, customers, and potential customers that maintain individual controlled-access network accounts with server 101.

Comedian 120 is registered with pitch server 101 and included in author database 115. Computer 125 communicates joke 130 with server 101, which stores joke 130 in works database 112. Server 101, following rules in database 117, assigns a share setting to joke 130 specifying a set of potential reviewers. The share setting can be a default setting, such as to present to all potential reviewers, or can sub-specify based on e.g. reviewer interest, collaborative grouping, work type, geographic location. In other embodiments some of information stored in the databases and the decisions and processes based on those data are instantiated on the client devices (e.g., computer 125). Wherever the data and processes take place, client devices make joke 130 available to the specified set of potential reviewers at some noted time of presentation. In embodiments that present works immediately the time of presentation and the time or receipt are practically the same. (In this context, a pitch is “presented” when it is made available to potential reviewers irrespective of whether the reviewers are logged onto pitch server 101 or review the presented content.)

In this example, three potential reviewers PR1-PR3 are shown to be logged into server 101, possibly via hosting website 102, via respective client applications running on conventional computing devices 143 and 144. The client applications can be general-purpose browsers, or can be tailored to make or support processes detailed herein. Potential reviewers PR1-PR3 interact with e.g. pitch server 101 or hosting server 102 on behalf of pitch server 101 to view joke 130. The client presentations each include voting icons 140 that allow potential reviewers PR1-PR3 to convey a vote relating to joke 130, either favorable or unfavorable. Other embodiments streamline voting by supporting only favorable votes or only unfavorable votes, or may support non-binary voting.

Per rules database 117, server 101 awaits receipt of a favorable vote relating to joke 130 from one of the set of potential reviewers selected for presentation. Should server 101 fail to receive a threshold number of favorable votes within a time elapsed from the presentation time, server 101 updates the share settings for joke 130 to reduce the number of potential reviewers. The elapsed time is adjusted for each potential reviewer depending upon e.g. the time of day reflected on the respective client computer. The set of potential reviewers may continue to decline with time absent favorable reviews. In some embodiments the number of potential reviewers can increase responsive to positive reviews or decrease responsive to negative reviews.

Using the specific example from FIG. 1, pitch server 101 receives joke 130 from comedian 120 and immediately makes joke 130 available to potential reviewers PR1-3. For each user logged onto server 101, if works database 112 lists the user as an author or editor of joke 130, then system 100 provides joke 130 with the author and other identifying information, such as an editor, collaborator, or business affiliated with comedian 120 or joke 130; otherwise, joke 130 is presented anonymously. If joke 130 receives a predetermined number of favorable votes system 100 can present joke 130 with attribution 150 to comedian 120. A vote tally 160 can also be presented when voting is sufficiently favorable. Maintaining anonymity unless and until a work receives favorable feedback encourages submission.

Pitches that do not receive a favorable response are subjected to a fading that gradually reduces the number of reviewers to which the joke is presented to smaller or otherwise different subsets of reviewers. The selected sets are not deterministic so the fading across multiple works reduces the overall workload of the reviewers. The time elapsed for a given pitch to decay is based in part on the time zone or active hours of each reviewer. Pitch fading reduces the work load on reviewers, time-zone shifting allows global participation, and pseudo-random or changing pitch subsets distributes the work of vetting works that are not immediately popular. In the instant example, joke 130 remains presented to the original set of potential reviewers if server 101 receives a favorable vote within ninety minutes of presentation. The vote threshold can be greater than one, or can be a mathematical combination of votes (e.g., an average or ratio of up/down votes). The time elapsed can also be other than ninety minutes, and the voting and time thresholds are user selected in some embodiments. Joke 130 remains available to all users if the voting threshold is met within the designated time threshold.

Server 101 keeps track of votes and shares voting information with client devices 143 and 144. Client devices keep track of indicia of votes locally, starting with a null set. If server 101 receives no favorable votes for joke 130, and consequently either shares no voting information or reports the absence of favorable votes, each client device 143 and 144 decides whether to present or continue to present joke 130 in the feed of the corresponding user. This decision considers the indicia of votes, the time joke 130 was first presented, and the time-of-day for the particular client device. If no favorable vote is noted in the tracked indicia of votes on the client device within the ninety-minute vote threshold Vth, and the presentation time stamp indicates that joke 130 was presented during a given reviewer's peak time (e.g., 8 AM to 11 PM), then joke 130 is subjected to a decay process that may remove joke 130 from that reviewer's feed. In one embodiment the decay process calculates a probability (chance) that joke 130 will be removed from a reviewer's feed as follows:

Let timeChance=The higher of (MC, 1.0−(hours past Vth*DR))

Where:

MC (minimum chance)=Server-side controlled variable set to e.g. 10%

DR (drop rate)=Server-side controlled variable set to e.g. 50%

For example, a joke pitched one hour past the ninety-minute vote threshold Vth has a 50% chance of being seen; 1.5 hours hour past the ninety minute vote threshold Vth has a 25% chance of being seen; and two or more hours has a 10% chance of being seen.

If the presentation time stamp indicates that joke 130 was presented outside of a given reviewer's peak time, then joke 130 is subjected to the foregoing decay process as though joke 130 was presented at the beginning of the reviewer's day (e.g. at 9 AM), or as though joke 130 was presented when the reviewer first logged onto server 101. If a California author presents a joke to a set of potential reviewers the includes members in Japan, for example, rules database 117 or similar rules residing on a Japanese client device may elect to toll a ninety-minute withdrawal period until the beginning of the workday in Japan. Such client-specific decisions can be made on the client device, with reference to local time, or can be made by server 101 either based on user data or upon receipt of timing synchronization from each client. In other embodiments server 101 controls the fading process by specifying the subsets of reviewers. This central control reduces the number of works conveyed over the network and stored on client devices, and thus improves the overall performance of system 100.

The pitch-fading process can take into account the number of works presented of a given type or for a given topic. The process is less likely to delete one of a few jokes relating to a topic of interest, for example, than to delete one of hundreds relating to the same topic. In one embodiment, for example, if a topic has forty or fewer pitches, then all pitches are shown regardless of time. If the topic has one hundred or more pitches, then the pitch-fading process is in full effect. A topic with pitches between forty and one hundred has the pitch-fading process applied in proportion to the abundance of pitches, the greater the number of votes the greater the probability of removing the joke from a reviewer's feed.

In some embodiments works database 112 can correlate each work to one or more fields of interest and reviewer database 114 can assign similar fields of interest to potential reviewers. For example, one reviewer may be interested in jokes, another in film proposals, and another in both. Works can be further divided into topics, such as to distinguish between political and slapstick comedy. These data can be collected from reviewer feedback to sub-specify sets of potential reviewers to receive pitches so that server 101 can present to an interested potential reviewer rather than to the whole set. Within an interested set, server may initially present to a random subset of potential reviewers as a test for quality before enlarging the target set, or may select a relatively large set and pare down based change the set based on reviewer feedback.

System 100 supports presentation rules that present works of authorship anonymously or with attribution based on feedback from potential reviewers, and with or without vote tallies. With reference to the example of potential reviewer PR1, the user interface includes an attribution 150 listing comedian 120 and vote tallies 160 indicating 256 positive and 17 negative votes. Rules database 117 causes server 101 to initially present works anonymously, adding attribution only if the presented work receives positive feedback, or a mix of positive a negative feedback (e.g., a ratio of “yes” and “no” votes), that exceeds a vote threshold. Anonymity for works that receive negative or insufficiently positive feedback is important as it encourages submission. The vote threshold can be adjusted to achieve a desired submission quality.

While the subject matter has been described in connection with specific embodiments, other embodiments are also envisioned. For example, the system detailed above for pitching joke can likewise be used to pitch other works of authorship, including literary, dramatic, musical, artistic, video, and other intellectual works. The term “author,” as used herein, thus refers to any person or organization that originates a work of authorship. Such people and entities include comedians, musicians, artists, screen writers, poets, journalists, architects, ad agencies, modeling agencies, and the institutions that employ them. Other variations will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A pitch filtering system for filtering pitches of works of authorship received from an Internet computer network by an individual controlled-access network account assigned to a reviewer, the pitch filtering system comprising:
a client computer generating network access requests for the individual controlled-access network account; and
client software, on the client computer, the client software to:
receive the pitches of works of authorship;
render the works of authorship for view on the client computer;
maintain indicia of votes for the works of authorship from other reviewers; and
calculate a probability of removing each of the works of authorship from the view on the computer responsive to the indicia of votes.

2. The pitch filtering system of claim 1, the client software to read a time local to the client computer, wherein calculating the probability considers the local time.

3. The pitch filtering system of claim 1, further comprising a server remote from the client computer, the server assigning a share setting to the works of authorship, the share setting specifying a set of the potential reviewers.

4. The pitch filtering system of claim 3, the server to present each of the works of authorship, at a presentation time, to the set of the potential reviewers.

5. The pitch filtering system of claim 3, the server to await receipt of votes relating to the original works of authorship from ones of the set of the potential reviewers and signal the votes to the client computer.

6. The pitch filtering system of claim 1, the client software to update the indicia of votes responsive to the signal.

7. The pitch filtering system of claim 1, wherein the works of authorship comprise jokes.

8. A computer-implemented method for sharing works of authorship with potential reviewers of the works of authorship, the method comprising:
maintaining a reviewer database listing the potential reviewers of the works of authorship;
receiving an original work of authorship from an author;
assigning a share setting to the original work of authorship, the share setting specifying a set of the potential reviewers;
presenting the original work of authorship, at a presentation time, to the set of the potential reviewers;
awaiting receipt of a vote relating to the original work of authorship from one of the set of the potential reviewers; and
updating the share setting after an elapsed time from the presentation time absent the vote relating to the original work of authorship.

9. The computer-implemented method of claim 8, further comprising attributing different ones of the potential reviewers to respective active times and calculating the elapsed time for the different ones of the potential reviews using the active times.

10. The computer-implemented method of claim 8, further comprising assigning the original work of authorship to a topic and updating the share setting responsive to the topic.

11. The computer-implemented method of claim 10, further comprising maintaining a count of works of authorship applied to the topic and updating the share setting responsive to the count.

12. The computer-implemented method of claim 8, further comprising presenting the original work of authorship to a second set of the potential reviewers responsive to the updating of the share settings.

13. The computer-implemented method of claim 12, wherein the second set of the potential reviewers includes fewer of the potential reviewers than the first-mentioned set of the potential reviewers.

14. The computer-implemented method of claim 8, wherein the updating the share setting comprising hiding the original work of authorship on a client device associated with one of the potential reviewers.

15. The computer-implemented method of claim 14, further comprising, on a second client device associated with a second of the potential reviewers, allowing the second client device to display the original work of authorship after the elapsed time absent the vote relating to the original work of authorship.

16. The computer-implemented method of claim 15, further comprising separately calculating, on the first-mentioned client device and second client device, respective first and second probabilities of displaying the original work of authorship.

17. The computer-implemented method of claim 8, wherein assigning the share setting comprises applying a default sharing status to the original work of authorship.

18. The computer-implemented method of claim 8, wherein the original work of authorship comprises a joke.

19. The computer-implemented method of claim 8, further comprising maintaining anonymity of the author in presenting the original work of authorship to the set of the potential reviewers.

20. The computer-implemented method of claim 19, further comprising counting votes favorable to the original work of authorship and maintaining the anonymity of the author in presenting the original work of authorship.

21. The computer-implemented method of claim 20, further comprising presenting an identity of the author with the original work of authorship if the votes favorable to the original work of authorship exceed a vote threshold.

22. The computer-implemented method of claim 21, further comprising presenting the identity of the author with the original work of authorship if the votes favorable to the original work of authorship exceed the vote threshold within a second elapsed time from the presentation time.

23. The computer-implemented method of claim 8, further comprising updating the share setting responsive to a time of day.

24. The computer-implemented method of claim 8, wherein the author is not among the first-mentioned set of potential reviewers, the method further comprising presenting the original work of authorship to the author before and after updating the share setting.

25. The computer-implemented method of claim 8, further comprising:
receiving a second original work of authorship from a second author at a second presentation time;
applying a second time stamp, reflecting the second presentation time, to the second original work of authorship; and
assigning a second share setting to the second original work of authorship, the second share setting specifying a second set of the potential reviewers that is a second set of the potential reviewers different from the first-mentioned set of the potential reviewers.

26. The computer-implemented method of claim 25, wherein the reviewer database correlates the potential reviewers by their interest in work types, the method further comprising:
assigning the first-mentioned original work of authorship a first of the work types;
assigning the second original work of authorship a second of the work types;
specifying the first-mentioned set of the potential reviewers from among the potential reviewers correlated with the first of the work types; and
specifying the second set of the potential reviewers from among the potential reviewers correlated with the second of the work types.
